(19) United States
(12) Patent Application Publication
(10) Pub. No.: US 2019/0387910 A1
(43) Pub. Date: Dec. 26, 2019

(54) OUTDOOR SECURED DROP BOX FURNITURE AND METHOD OF USE

(71) Applicant: Terra Stoich, Marysville, WA (US)

(72) Inventor: Terra Stoich, Marysville, WA (US)

(21) Appl. No.: 16/446,553

(22) Filed: Jun. 19, 2019

Related U.S. Application Data
(60) Provisional application No. 62/689,000, filed on Jun. 22, 2018.

(51) Int. Cl. A47G 29/14; G07C 9/00

(52) U.S. Cl. CPC A47G 29/141; G07C 9/00142; G07C 9/00158

(57) ABSTRACT

An outdoor drop box furniture and method of use. The outdoor drop box furniture includes an interior receptacle, an outdoor furniture shell configured to conceal the interior receptacle, such as a sofa-style shell, park bench-style shell, or planter, and a locking mechanism comprising a passcode reader configured to receive a passcode and selectively allow access to the interior receptacle depending on the passcode. The method includes generating an access code, transmitting the access code to the deliverer, arranging a locking mechanism according to the access code, receiving a passcode entered by the deliverer, determining authorization to access the interior receptacle by comparing the access code and the passcode, based on the determination, opening the interior receptacle, and after removal of the item is removed, closing the interior receptacle and deleting the access code.

### CROSS-REFERENCE TO RELATED APPLICATIONS

This application claims priority to U.S. Provisional Application No. 62/689,000 filed on Jun. 22, 2018.

### FIELD OF THE DISCLOSURE

The present description relates generally to the field of secured receptacles. More specifically, the present description relates to embodiments for outdoor secured drop box furniture capable of allowing exclusive access to authorized persons and method of use.

### BACKGROUND

Currently, there are a number of existing products for secured drop boxes that are designed to receive packages. Conventional receptacles include lockable box shaped receptacles or wall mounted receptacles with a traditional locking mechanism requiring a physical key to gain access. Alternatively, there are some existing receptacles that are connectable to a communication device that allows access to the receptacles for specifically pre-authorized delivery persons. Further, some other alternatives include security boxes hidden in indoor furniture to hide and secure valuables or weapons. However, there are still many security risks and thefts that happen with all of the existing options. Notably, the conventional receptacles do not provide for a secure receptacle or drop box that may also function as outdoor furniture to hide its identity from passerby and that is also equipped with a remote access control to allow exclusive access only to authorized persons.

### SUMMARY

The disclosure presented herein relates to an outdoor secured drop box furniture. In one embodiment, the drop box includes an outdoor furniture shell, a receptacle, and an electronically controlled locking mechanism. The outdoor furniture shell may be any outdoor furniture including, but not limited to, a sofa, a chair, a table, and a bench. The locking mechanism may be controlled electronically with a digital means that may be accessed online using the Internet or via any other communication means over a network. The locking mechanism may be additionally controlled manually with a physical key.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1A is a perspective view depicting an exemplary piece of outdoor furniture that includes a secured drop box according to embodiments of the present invention.

FIG. 1B is a perspective view of the piece of outdoor secured drop box furniture of FIG. 1A, showing the interior receptacle slid open from the hollow body.

FIG. 1C is a perspective view of the piece of outdoor secured drop box furniture with a hatch open on top of the interior receptacle.

FIG. 2 is a flow chart depicting a method of using an outdoor secured drop box furniture according to embodiments of the present invention.

### DETAILED DESCRIPTION

In the Summary above, this Detailed Description, the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range having a lower limit and an upper limit corresponding to the first number and the second number, respectively. For example, 25 to 100 mm means a range whose lower limit is 25 mm and upper limit is 100 mm.

These days it is very common for people to order their packages and products online to be shipped to either their homes or businesses. With the great increase in online shipments to one's home or business or other location, there is also a high rate of thefts occurring by package thieves who pass by and grab the packages without permission to do so. It is a serious problem for individuals whose purchased items are stolen and also for the package deliverers and companies of origin that have to contend with reshipping the products or providing refunds for stolen items, and thereby losing money and time. Moreover, for time-sensitive delivery items such as groceries and some medications that need temperature-controlled storage, online deliveries often fail when the items are left outside unattended for a long time until the recipient gets home and picks them up. Accordingly, in recent years, there have been some attempts to provide some security for one's package when delivered. To reduce thefts, e-commerce and logistics companies have built lockers in densely populated places so that consumers who order goods may visit the lockers and pick up the goods they purchased. Consumers receive the location of their designated lockers with access codes, sometimes with time window during which they are allowed to pick up their goods. However, these lockers are inconvenient and defeats the purpose of online shopping because consumers will have to travel to another location other than their residence or business in order to access these lockers.

Alternatively, some companies offer services where a delivery person comes into the consumer's house and leaves the package inside the house, however, this is not a very popular option, because the homeowners have to provide access to delivery persons that they do not know to come into their private homes to deliver packages.

Another option is that porch lock boxes may be installed in front of private homes. However, these porch lock boxes are unattractive. Moreover, they are conspicuously exposed to passersby and are clearly functioning as a storage locker. These porch lock boxes and other similar items become an easy target of theft, because they are not equipped with advanced technologies as used in commercial lock boxes. Additionally, these porch lock boxes lack refrigeration and/or heating to keep disposable items for a long time. Therefore, a new kind of convenient, secured, temperature-controlled drop box is needed that may also be kept near or at a person's home or business or other convenient location.

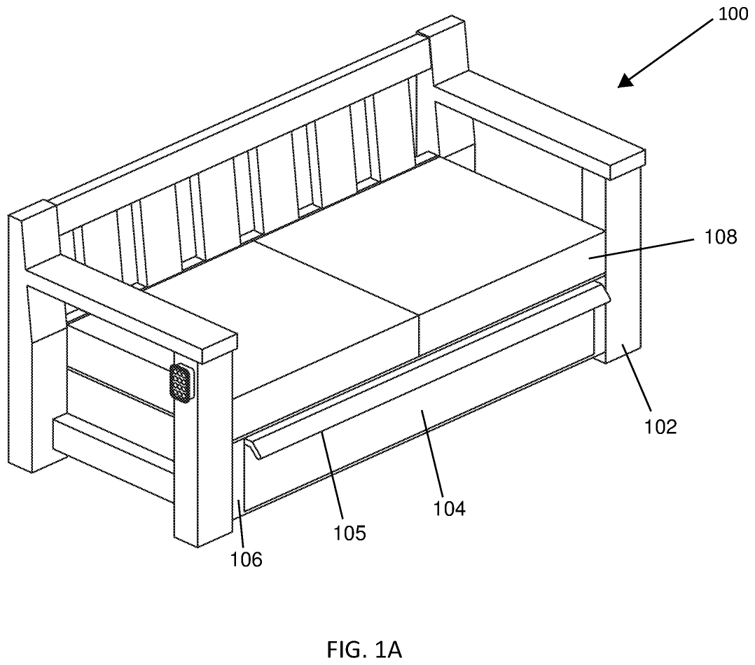

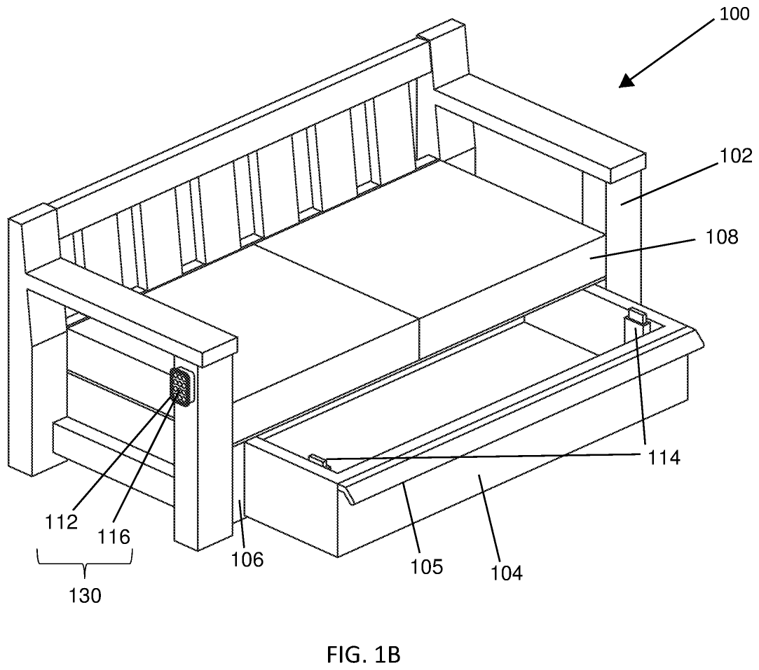

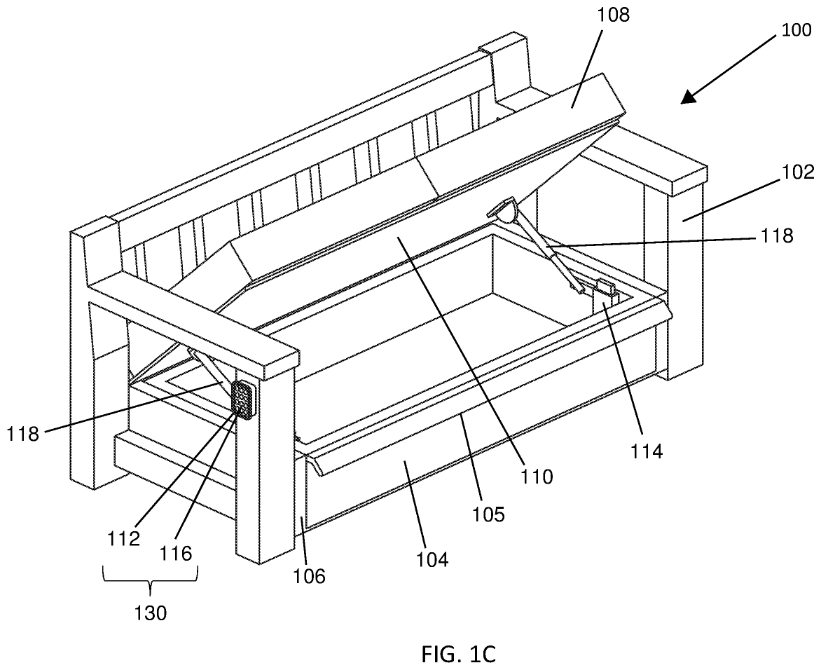

FIGS. 1A-1C are perspective views of an outdoor secured drop box furniture (“drop box”) 100. In one or more embodiments, the drop box 100 includes an outdoor furniture shell (“shell”) 102 with a hollow body 106. The shell 102 may be configured to appear like a piece of outdoor furniture, such as, but not limited to, an outdoor bench or any other type of furniture piece commonly placed in the exterior of a house. The shell 102 can be one of many styles of outdoor furniture. For example, shell 102 may be designed as a sofa with seat cushions and pillows. Alternatively, shell 102 may be designed in the form of a park bench, such as a bench having a hard, smooth seating surface. In another embodiment, shell 102 may be designed to be a lounge chair or other type of outdoor chair. In other embodiments, the shell 102 may be a planter such as a large flower pot. The shell 102 is configured to be suitable to long term use, primarily, when exposed to outdoor elements, including rain, sun, wind, snow. The shell 102 may be made out of wood, metals such as steel, stainless steel and aluminum, plastic, rubber, fabric, glass, or any other material or combination thereof that are used for making conventional furniture by a person having ordinary skill in the art. Some or all parts and components of the drop box 100 may be made waterproof in order to protect the contents, such as parcels, stored inside the drop box 100.

In an embodiment where the shell 102 is a sofa with cushions 108, the hollow body 106 may be located below the cushions 108, hidden from people. In this embodiment, the hollow body 106 has an opening at the front of the shell 102 such that an interior receptacle 104 may slide into the hollow body 106 from the front, as shown in FIG. 1B. A slide rail or hydraulic slide rail (not shown) may be installed on each inner side of the hollow body 106 so that the interior receptacle 104 can slide open and close. In some embodiments, there may be a protruding handle or grip 105 that runs along the length of the front of interior receptacle 104 so that a user may easily pull open and push shut interior receptacle 104.

As shown in FIG. 1B, the interior receptacle 104 may be empty and may be sized having various dimensions. Interior receptacle 104 may be customized in size and shape for certain types of packages or parcels. Interior receptacle 104 is configured to hold any type of item or package containing any type of goods or products, including, without limitation, groceries, medicine, flowers, gifts, or any other type of item.

Alternatively, as shown in FIG. 1C, the drop box 100 may have ainterior hatch 110 located within shell 102 rather than a sliding drawer (as shown in FIG. 1B). Accordingly, interior receptacle 104 may be in the form of hatch 110, such that a person accessing the interior receptacle 104 lifts up the cushions 108, raises up or otherwise pulls open the top surface of the hollow body 106, and in this way, is able to gain access to the interior receptacle 104. In some embodiments, the hatch 110 may be located beneath cushions 108, as shown in FIG. 1C. In some other embodiments, the hatch 110 may be located at the front of the interior receptacle 104, which can also be locked shut to prevent access.

The interior receptacle 104 may also have a refrigeration system to keep the inside of the interior receptacle 104 cold when necessary, for instance, to keep delivered groceries cool. Additionally, or separately in some embodiments, the interior receptacle 104 may also have a heating system to keep the inside of the interior receptacle 104 warm when necessary. In these embodiments, the drop box 100 may include the circuitry necessary to keep the interior receptacle 104 at a desired temperature. In some embodiments, the refrigerator system and the heating system may coexist in one drop box 100, where the drop box 100 has a plurality of interior receptacles 104 compartmentalized and maintained at different interior temperatures. The locking mechanism 130 may also have sensors (not shown) that determine when the hatch 110 is completely closed. The sensors (not shown) may automatically lock the interior receptacle 104 upon determining the hatch 110 is completely closed.

In the sofa-style drop box 100, the cushions 108 help concealing the existence of the interior receptacle 104 from passersby and prevent theft of the contents in the interior receptacle 104 or damaging the drop box 100. In embodiments where the hatch 110 is located at the front of the interior receptacle 104, the hatch 110 may look like the base frame of an outdoor furniture piece such as the base frame of a sofa. Other types of concealment may be achieved as appropriate for the shell 102 while also having the appearance of a different kind of furniture. For example, the shell 102 that looks like a large flower pot may have the hollow body 106 in the pot concealed beneath any flowers or plants that are planted in the flower pot. The hatch 110 can be locked, unlocked, and opened by a user who wants to access any contents located within the interior receptacle 104.

The drop box 100 may have an electronically assisted mechanical lift (not shown) that electrically powers the interior receptacle 104 to be elevated upward, pushed forward, or otherwise extended or moved out of the hollow body 106. As shown in FIG. 1C, the hatch 110 on the interior receptacle 104 may have connectors 118 such as mechanical or hydraulic hinges.

Separately from or in combination with the hatch 110, the drop box 100 may have a locking mechanism 130 that controls access to the interior receptacle 104 and keeps the contents secured within the interior receptacle 104. Referring to FIGS. 1B-1C, the locking mechanism 130 may include a lock panel 112 and one or more locks 114 electrically and/or mechanically connected to the lock panel 112. The lock panel 112 may be configured to control the open and shut operations of the locks 114. In embodiments equipped with connectors 118 as in FIG. 1C, the lock panel 112 may also be electrically connected to the connectors 118 and configured to control the opening and closing of the connectors 118. As shown in FIGS. 1A-1C, the lock panel 112 may be apparent and visible to passersby. Alternatively, in other embodiments, the lock panel 112 may also be hidden or concealed from passersby so as to help preventing potential theft or damage.

In some embodiments, the locking mechanism 130 may also include a means of communication over one or more networks for data to be transferred to and from locking mechanism 130. The means of communication may be configured to connect the locking mechanism 130 with the owner of the drop box 100 via a wired or wireless connection and using one or more communication protocols, including but not limited to a direct electrical connection, ETHERNET, WI-FI, BLUETOOTH, a cellular communication network, or any other means of communication known to those of ordinary skill in the art. In this manner, locking mechanism 130 may be communicatively connected with either the owners or users of locking mechanism 130 and also with other authorized users, such as a parcel deliverer or delivery service company.

In one embodiment, the lock panel 112 may be a mechanical lock (not shown), such as the type of mechanical lock that may be unlocked or locked using a physical key. In other embodiments, the lock panel 112 may have a touch pad (not shown) on one of its outside surfaces. In still other embodiments, the lock panel 112 may have a numeric keypad 116 on one of the outside surfaces, as shown in FIGS. 1A-1C. Further, lock panel 112 may include physical raised buttons or may be a single touch screen with touch screen activated buttons in some embodiments.

Using various techniques known to a person having ordinary skill in the art and using the means of communication described above, the lock panel 112 may be configured to provide access to the interior receptacle 104 only to such users it authorizes, for example parcel deliverers. Parcel deliverers may also be provided special instructions about the drop box 100 including the location of the inner receptacle 104 as well as which outdoor object is the drop box 100 itself.

In operation, a user may enter the passcode onto the lock panel 112 to gain access to the interior receptacle 104. The passcode may be a combination of numbers in case of the numeric keypad 116, or the passcode may be a graphical pattern in case of the touch pad, or any other ways known to a person having ordinary skill in the art may be used. Such passcode may be generated by the locking mechanism 130 when the owner of the drop box 100 locks the interior receptacle 104. Alternatively, the passcode may be generated by a separate remote system connected to the locking mechanism 130 and transferred to an authorized user of locking mechanism 130 via a communication network (including via BLUETOOTH, WI-FI, cellular connection, or any other type of communication network whether wired or wireless) and sent to the locking mechanism 130 when the owner of the drop box 100 locks the interior receptacle 104. The passcode may be stored in a memory (not shown) within the locking mechanism 130, or the passcode may be stored in a memory in the separate remote system and later accessed by the locking mechanism 130 via the communication network.

Drop box 100 may be useful at both residences, including apartments, trailers, or any other type of residences, as well as also be useful at businesses. Drop box 100 may be placed anywhere that is suitable including outdoors at the front or back of an establishment, on a porch, in a cellar, on a curb or other border/edge of a property.

In some embodiments, a user may scan an electromagnetic fob over the lock panel 112. A specific electromagnetic fob may be preprogrammed and configured to connect wirelessly over a communication network. Such a communication network may include, without limitation, a WI-FI communication link, a BLUETOOTH communication link, a cellular communication link, or any other type of communication link in order for data to be transferred and shared over the communication network either wirelessly or through a wired connection to lock panel 112.

Still in some embodiments, lock panel 112 may be adapted to receive biometric information from an authorized user. Accordingly, lock panel 112 may be configured to receive biometric information such as, without limitation thereto, fingerprint, palm prints or veins, facial recognition, voice recognition, DNA, hand geometry, iris recognition, retina, and/or a specific odor/scent. The lock panel 112 may be configured so that the specific biometric information may be associated with prior authorization for a user. In some cases, it may be feasible for the authorization to be transferred over a communication network, including via a WI-FI connection, BLUETOOTH connection, cellular connection, or any other type of communication connection known to those of ordinary skill in the art.

Alternatively, the lock panel 112 may have a barcode reader (not shown). In this case, a user may scan a barcode generated by a code generator software program. When the locking mechanism 130 recognizes the scanned barcode as one of the authorized barcodes, the user is verified and allowed access to the interior receptacle 104. Various barcodes known to a person having ordinary skill in the art may be used, including one-dimensional barcodes such as UPC codes, EAN codes, Code 39, Code 128, ITF, Code 93, Codabar, GS1 Databar, and MSI Plessey, and two-dimensional barcodes such as QR codes, Datamatrix, PDF417, and AZTEC, without limitation. For one-dimensional barcodes, in one embodiment, the barcode reader may include a laser scanner. For two-dimensional barcodes, in one embodiment, the barcode reader may include a digital camera.

Once the owner of the drop box 100 sets the condition for authorization to access the interior receptacle 104, the information about such authorization may be notified to authorized parcel deliverers that the owner or user designates using the communication network described above.

In some embodiments, the locking mechanism 130 may have an anti-theft alarm (not shown). The anti-theft alarm sounds an alarm and/or notifies the owner of the drop box 100, security personnel or any other designated party when there is an unauthorized attempt to open or tamper the interior receptacle 104. Such notification may be communicated via the communication network described above.

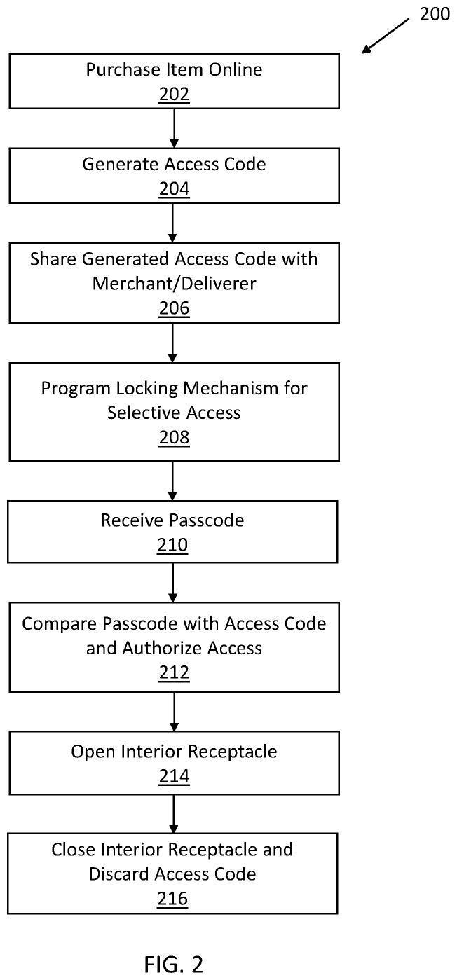

Referring to FIG. 2, a flow chart 200 depicting a method of using the outdoor drop box furniture is shown. The drop box 100 may be controlled electronically such that the drop box 100 may be unlocked by the owner of a property on which the drop box 100 is located or by someone delivering a package or both. In the first step 202, the owner (consumer) may purchase one or more items online to be delivered to her home. In step 204, an access code may be generated. In some embodiments, the access code may be generated by the merchant from which the consumer purchased the items. Alternatively, in some embodiments, the access code may be generated by the consumer. In step 206, the generated access code is shared between the consumer and the merchant via a communication network (including via BLUETOOTH, WI-FI, cellular connection, or any other type of communication network whether wired or wireless). In the embodiments where the consumer generated the access code, the access code is transmitted from the consumer to the merchant. In the alternative embodiments where the merchant generated the access code, the access code is transmitted from the merchant to the consumer. The merchant may further share the access code with a package deliverer who will physically deliver the purchased items to the consumer.

In step 208, a locking mechanism 130 is arranged according to the generated access code. “Arranging” as used herein means to lock the interior receptacle 104 and programming the locking mechanism 130 to allow access only to a person entering a passcode that matches the access code. As described above, the interior receptacle 104 is hidden or concealed within an outdoor furniture shell 102 such that passersby may not notice that some valuable goods may be stored in the outdoor furniture shell 102. In step 210, the locking mechanism 130 receives a passcode entered by the package deliverer or the merchant from whom the consumer purchased the items. In step 212, the locking mechanism 130 compares the access code and the entered passcode and determines whether to authorize or deny access to the interior receptacle 104. In step 214, based on the determination made in the previous step 212, the locking mechanism 130 opens the interior receptacle 104. In the final step 216, once the merchant or the deliverer drops the item in the interior receptacle 104 and closes the interior receptacle 104, the locking mechanism 130 locks the interior receptacle 104 and discards the access code by deleting the access code from a memory within the locking mechanism 130.

While embodiments have been illustrated and described, as noted above, many changes can be made without departing from the spirit and scope of the OUTDOOR SECURED DROP BOX FURNITURE. Accordingly, the scope of the OUTDOOR SECURED DROP BOX FURNITURE is not limited by the disclosure of these preferred and alternate embodiments. Instead, the scope of the invention title is determined entirely by reference to the claims. Insofar as the description above and the accompanying drawings (if any) disclose any additional subject matter that is not within the scope of the claims below, the inventions are not dedicated to the public and Applicant hereby reserves the right to file one or more applications to claim such additional inventions.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent, or similar purpose, unless expressly stated otherwise. Thus, unless expressly stated otherwise, each feature disclosed is one example of a generic series of equivalent or similar features.

Any element in a claim that does not explicitly state “means for” performing a specified function, or “step for” performing a specific function is not to be interpreted as a “means” or “step” clause as specified in 35. U.S.C. § 112 ¶6. In particular, the use of “step of” in the claims herein is not intended to invoke the provisions of U.S.C. § 112 ¶6.

What is claimed is:

1. An outdoor drop box furniture, comprising:
an interior receptacle;
an outdoor furniture shell configured to conceal the interior receptacle; and
a locking mechanism comprising a passcode reader configured to receive a passcode and selectively allow access to the interior receptacle depending on the passcode.

2. The outdoor drop box furniture of claim 1, wherein the passcode is a mechanical key.

3. The outdoor drop box furniture of claim 1, wherein the passcode is a barcode.

4. The outdoor drop box furniture of claim 1, wherein the passcode is a biometric information.

5. The outdoor drop box furniture of claim 1, wherein the outdoor furniture shell is a sofa.

6. The outdoor drop box furniture of claim 1, wherein the outdoor furniture shell is a planter.

7. The outdoor drop box furniture of claim 1, wherein the locking mechanism further comprises an access code.

8. The outdoor drop box furniture of claim 7, wherein the locking mechanism selectively allows access to the interior receptacle depending on whether the passcode matches the access code.

9. The outdoor drop box furniture of claim 7, wherein the locking mechanism is further configured to communicate over a communication network to transfer and receive data including the access code.

10. The outdoor drop box furniture of claim 9, wherein the access code is generated by the locking mechanism and transmitted to an authorized user.

11. The outdoor drop box furniture of claim 9, wherein the access code is generated by the server and transmitted to the locking mechanism.

12. The outdoor drop box furniture of claim 1, wherein the locking mechanism further comprises a sensor configured to detect whether the interior receptacle is closed or open.

13. The outdoor drop box furniture of claim 1, wherein the locking mechanism further comprises a key panel and a receptacle lock electronically connected to the key panel, and wherein the key panel opens and closes the receptacle lock depending on the passcode.

14. The outdoor drop box furniture of claim 1, wherein the locking mechanism further comprises an anti-theft alarm.

15. The outdoor drop box furniture of claim 1, wherein the interior receptacle comprises a refrigerated compartment.

16. The outdoor drop box furniture of claim 1, wherein the interior receptacle comprises a heated compartment.

17. A method of selectively allowing access to an outdoor drop box furniture storage, comprising:
generating an access code;
sharing the access code between a first user to a second user;
arranging a locking mechanism according to the access code, wherein
the locking mechanism is configured to control access to an interior receptacle, and
the interior receptacle is hidden within an outdoor furniture shell;
receiving a passcode entered by the deliverer;
determining authorization to access the interior receptacle by comparing the access code and the passcode;
based on the determination, opening the interior receptacle; and
after removal of the item is removed, closing the interior receptacle and deleting the access code.

18. The method of claim 17, wherein the sharing the access code between the first user to the second user is transmitting the access code to a server communicatively connected to the locking mechanism.

19. The method of claim 18, further comprising, providing the transmitted access code to a deliverer of the item.

20. The method of claim 17, wherein the access code is generated remotely on a server communicatively connected to the locking mechanism, and the sharing the access code between the first user to the second user is transmitting the access code from the server to the locking mechanism.
